(19) United States
(12) Patent Application Publication
(10) Pub. No.: US 2016/0098863 A1
(43) Pub. Date: Apr. 7, 2016

(54) COMBINING A DIGITAL IMAGE WITH A VIRTUAL ENTITY

(71) Applicant: TELEFONAKTIEBOLAGET L M ERICSSON (PUBL), Stockholm (SE)

(72) Inventors: Qingyan LIU, Beijing (CN); Vincent HUANG, Sollentuna (SE)

(21) Appl. No.: 14/893,451

(22) PCT Filed: Jun. 6, 2013
(86) PCT No.: PCT/CN2013/076835

§ 371 Date: Nov. 23, 2015

(51) Int. Cl. G06T 19/00; G06K 9/62; G06F 3/0484; G06T 11/60; G06T 7/00

(52) U.S. Cl. CPC G06T 19/006; G06T 11/60; G06T 7/004; G06T 7/0051; G06F 3/04842; G06K 9/6202; G06T 2207/10004; G06T 2207/10028; G06T 2207/20221

(57) ABSTRACT

An image combining apparatus obtains a digital image comprising picture elements and captured at an image capturing position. The picture elements forms different objects, where each formed object has at least one distance value representing the distance between the image capturing position and a real object that the corresponding formed object depicts. The image combining apparatus receives a user selection of a virtual entity to be combined with the digital image, obtains at least one distance value associated with the virtual entity representing the distance between a user selection of a location at which location the virtual entity is to appear to be placed and the image capturing position, compares the distance values, and combines the virtual entity with the digital image to create a combined image based on the comparison and with preference given to the lowest distance.

### TECHNICAL FIELD

The invention relates to the handling of digital images. The invention more particularly relates to an image combining apparatus, a vehicle comprising an image combining apparatus as well as to a method, computer program and computer program product for combining a virtual object with a digital image.

### BACKGROUND

The capturing of digital images and the providing of various effects of digital images has become widespread through the introduction of cameras in mobile terminals.

Images are typically captured from a position, an image capturing position, and objects depicted in the image are in real life provided at a distance to this image capturing position. However, the image itself is two-dimensional.

It has also become interesting to manipulate images in various ways. One such manipulation that may be of interest to a user is to combine images with virtual entities in order to achieve special effects.

US 2010/0045869 does for instance describe the use of an augmented reality marker in video images. A user may then place at virtual entity at the position of the augmented reality marker and thereafter the video is combined with the virtual entity. The exemplified virtual entity is an animation.

However, the user may furthermore want the virtual entity to appear to be placed at a distance from the image capturing position that is selected by the user him- or herself.

As images are two-dimensional there is no way for the user to easily insert another object in an image and obtain the desired effect.

It is in the field of video processing known to provide depth data in relation to images. This is for instance described in U.S. Pat. No. 7,295,697. However, such depth data is used for MPEG coding, i.e. in relation to movement of objects in consecutive images of a frame of video. The depth data is thus heavily embedded in the coding format. This technique can therefore not easily be adapted for allowing user influence or use of such depth data in digital images.

There is therefore a need for allowing users to combine a digital image with a virtual entity, which allows the user to make the virtual entity appear to be placed at a location that is selected by him or her.

### SUMMARY

One object of the invention is to enable combination of a digital image with a virtual entity to be made that allows a user to make the virtual entity appear to be placed at a location that is selected by him or her.

This object is according to a first aspect achieved by an image combining apparatus that comprises a processor and memory. The, memory contains instructions executable by the processor whereby the image combining apparatus is operative to obtain a digital image comprising picture elements, where the digital image has been captured at an image capturing position and the picture elements form different objects. Each formed object has at least one distance value representing the distance between the image capturing position and a real object that the corresponding formed object depicts. The apparatus is further operative to receive a user selection of a virtual entity to be combined with the digital image, to obtain at least one distance value associated with the virtual entity representing the distance between a user selection of a location at which location the virtual entity is to appear to be placed and the image capturing position, compare the distance value of the virtual entity with the distance values in the digital image, and combine the virtual entity with the digital image to create a combined image based on the comparison and with preference given to the lowest distance.

A second aspect of the invention is concerned with a vehicle or a vessel that comprises the image combining apparatus according to the first aspect.

The object is according to a third aspect also achieved by a method of combining a virtual object with a digital image. The method is performed in an image combining apparatus and comprises obtaining the digital image comprising picture elements, where the digital image has been captured at an image capturing position. The picture elements also form different objects, where each formed object has at least one distance value. A distance value in turn represents the distance between the image capturing position and a real object that the corresponding formed object depicts. The method also comprises:

receiving a user selection of a virtual entity to be combined with the digital image,
obtaining at least one distance value associated with the virtual entity representing the distance between a user selection of a location at which location the virtual entity is to appear to be placed and the image capturing position,
comparing the distance value of the virtual entity with the distance values in the digital image, and
combining the virtual entity with the digital image to create a combined image based on the comparison and with preference given to the lowest distance.

The object is according to a fourth aspect also achieved by a computer program for combining a virtual object with a digital image. The computer program comprises computer program code which when run in an image combining apparatus, causes the image combining apparatus to obtain the digital image comprising picture elements, where the digital image has been captured at an image capturing position. The picture elements form different objects, where each formed object has at least one distance value. A, distance value in turn represents the distance between the image capturing position and a real object that the corresponding formed object depicts. The computer program code also causes the image combining apparatus to:

receive a user selection of a virtual entity to be combined with the digital image,
obtain at least one distance value associated with the virtual entity representing the distance between a user selection of a location at which location the virtual entity is to appear to be placed and the image capturing position,
compare the distance value of the virtual entity with the distance values in the digital image, and
combine the virtual entity with the digital image to create a combined image based on the comparison and with preference given to the lowest distance.

The object is according to a fifth aspect also achieved by a computer program product for combining a virtual object with a digital image. The computer program product is provided on a data carrier and comprises the computer program code according to the fourth aspect.

In one variation of the first aspect, the instructions to combine comprise instructions to select either a part of the virtual entity or a formed object of the digital image for which the corresponding distance value represents the shortest distance to the image capturing position. In this case the creating is based on the selected part or object.

In a corresponding variation of the third aspect, the combining comprises either selecting a part of the virtual entity or a formed object of the digital image for which the corresponding distance value represents the shortest distance to the image capturing position in the comparison. In this case the creating is based on the selected part or object.

The digital image may be provided in a first presentation layer and the virtual entity in a second presentation layer adjacent the first layer. In another variation of the first aspect, the instructions to select comprise instructions to select parts of a corresponding layer for presentation.

In a corresponding variation of the second aspect, the selecting comprises selecting parts of a corresponding layer for presentation.

In yet another variation of the first aspect, the instructions comprise instructions causing the image combining apparatus to present the combined digital image and virtual entity.

In a corresponding variation of the second aspect, the method comprises presenting the combined digital image and virtual entity.

In a further variation of the first aspect, the image combining apparatus further comprises an image capturing unit configured to capture the digital image. The instructions further comprise instructions causing the image combining apparatus to determine the distance values of the objects based on detected movement of the image capturing position.

In a corresponding variation of the second aspect, the method further comprises capturing the digital image and determining the distance values of the objects based on detected movement of the image capturing position.

In yet a further variation of the first aspect, the instructions further comprise instructions causing the image combining apparatus to determine the formed objects in the digital image and to determine the distance values through determining the movement of these formed objects in relation to the detected movement of the image capturing position.

In a corresponding variation of the second aspect, the method further comprises determining the formed objects in the digital image and determining the distance values through determining the movement of these formed objects in relation to the detected movement of the image capturing position.

In yet another variation of the first aspect, the image capturing unit is configured to detect the movement of the image capturing position.

In another variation of the first aspect, there is a detector configured to detect the movement of image capturing position.

In yet another variation of the first aspect, the instructions comprise instructions. the image combining apparatus is further operative to obtain data specifying an area in the digital image that is to be combined with the virtual entity

In a corresponding variation of the second aspect, the method comprises obtaining location data specifying where in the digital image the virtual entity is to be placed.

The invention has a number of advantages. An image combination is obtained where a depth effect is obtained. This leads to a better and more realistic combination of the virtual entity with the digital image.

It should be emphasized that the term “comprises/comprising” when used in this specification is taken to specify the presence of stated features, integers, steps or components, but does not preclude the presence or addition of one or more other features, integers, steps, components or groups thereof.

### BRIEF DESCRIPTION OF THE DRAWINGS

The invention will now be described in more detail in relation to the enclosed drawings, in which:

FIG. 1 schematically shows a mobile terminal communicating with a server via a wireless communication network, where either the mobile terminal, the server or both the mobile terminal and server may form an image combining apparatus,

FIG. 2 shows a block schematic of various units of the mobile terminal,

FIG. 3 shows a block schematic of the content of a memory of the mobile terminal,

FIG. 4a shows a first digital image,

FIG. 4b shows a virtual entity,

FIG. 5 shows a combined image obtained through combining of the digital image with the virtual entity,

FIG. 6 shows a number of method steps being performed in a first variation of a method of combining a virtual entity with a digital image,

FIG. 7 shows pixels of the digital image together with a distance map with distances associated with the pixels,

FIG. 8 schematically shows the providing of the virtual entity on top of the digital image,

FIG. 9 schematically shows an example of a combined virtual entity and digital image,

FIG. 10 schematically shows the capturing of real objects in the digital image and their placement in relation to an image capturing position,

FIG. 11 shows a number of method steps being performed in order to determine distance values of a digital image,

FIG. 12 shows a number of method steps being performed in a second variation of a method of combining a virtual entity with a digital image,

FIG. 13 schematically shows a vehicle which comprises the image combining apparatus, and

FIG. 14 shows a computer program product in the form of a data carrier with computer program code implementing the image combining apparatus

### DETAILED DESCRIPTION

In the following description, for purposes of explanation and not limitation, specific details are set forth such as particular architectures, interfaces, techniques, etc. in order to provide a thorough understanding of the invention. However, it will be apparent to those skilled in the art that the invention may be practiced in other embodiments that depart from these specific details. In other instances, detailed descriptions of well-known devices, circuits and methods are omitted so as not to obscure the description of the invention with unnecessary detail.

The invention is generally directed towards the combining of images with virtual entities.

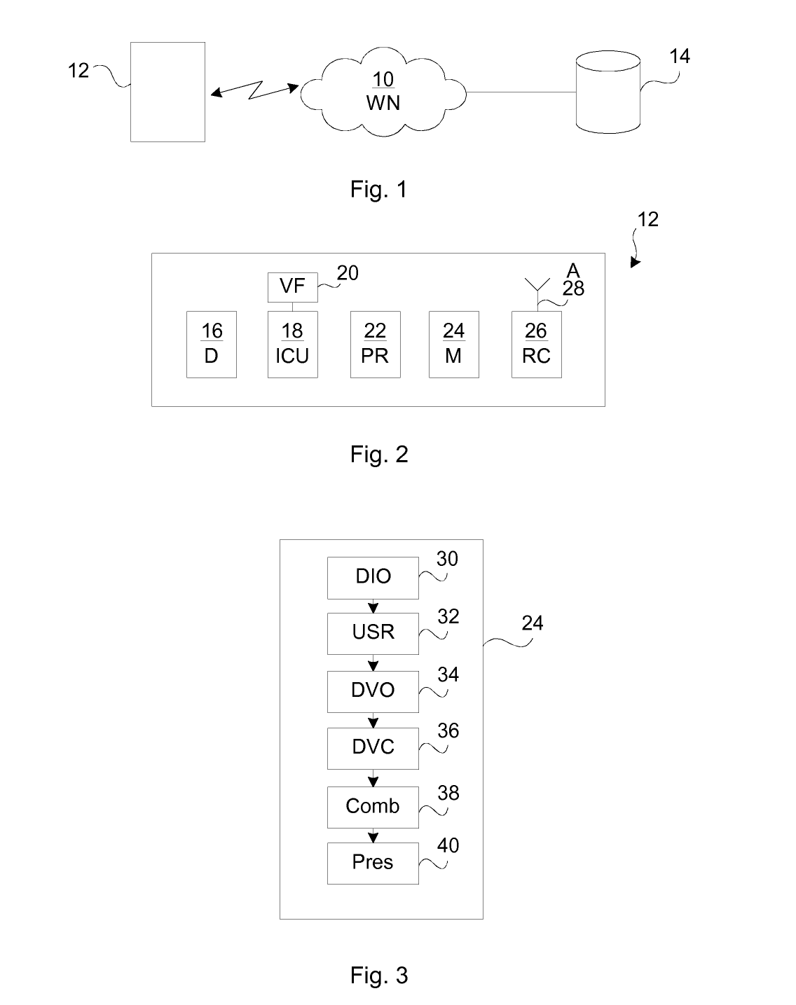

FIG. 1 schematically shows a mobile terminal 12 communicating with a server 14 via a wireless network WN 10. The mobile terminal 12 may be equipped with a camera, which may thus be able to capture images. The camera is therefore one type of image capturing unit, which term will be used in the following instead of camera.

A user, for instance a user of the mobile terminal 12, may be interested in combining digital images with virtual entities, where a virtual entity may be another digital image, a digital presentation slide, a string of text, an animation or any other type of visual information that can be presented using digital data. In order to allow a user to perform this combining there is provided an image combining apparatus. The image combining apparatus may be provided by the server 14, by the mobile terminal 12 or by a combination of the mobile terminal 12 and server 14.

FIG. 2 shows a block schematic of an exemplifying mobile terminal 12 that may be used. It comprises a display D 16, an image capturing unit ICU 18 connected to a viewfinder VF 20, a processor PR 22, a memory M 24 and a radio circuit RC 26 connected to an antenna A 28. The display D 16, an image capturing unit ICU 18, processor PR 22, memory M 24 and radio circuit RC 26 may also be connected to an internal bus (not shown).

In one variation, the mobile terminal 12 forms the image combining apparatus and in this case it comprises computer program code or instructions, which are executable by the processor 22. These instructions make the processor implement the functionality of the image combining apparatus.

FIG. 3 schematically shows the instructions according to this variation. The instructions may be provided as units or subunits connected to each other in a sequence. There is in this case a digital image obtaining unit DIO 30 connected to a user selection receiving unit USR 32. The user selection receiving unit 32 is in turn connected to a distance value obtaining unit DVO 34, which in turn is connected to a distance value comparing unit DVC 36. The distance value comparing unit DVC 36 is furthermore connected to a combiner Comb 38, which in turn is connected to a presenting unit Pres 40.

The units in the example above are thus realized as computer program instructions. However, it should be realized that they may also be realized in the form of hardware, for instance using logic circuits. Furthermore, in the example where the apparatus is provided by the server 14, then the above mentioned instructions would be provided in a memory of this server and acted upon by a processor of the server 14. Also the server could of course also use logic circuits.

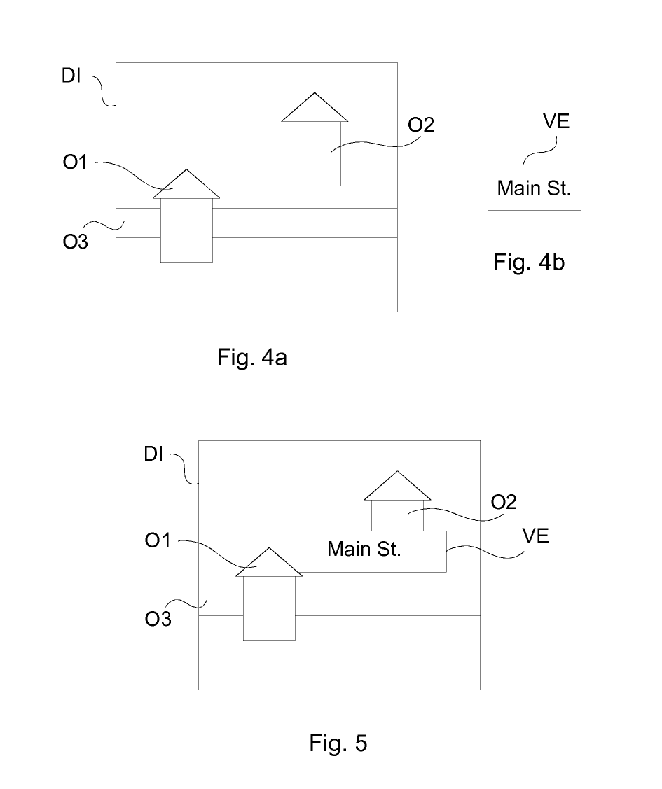

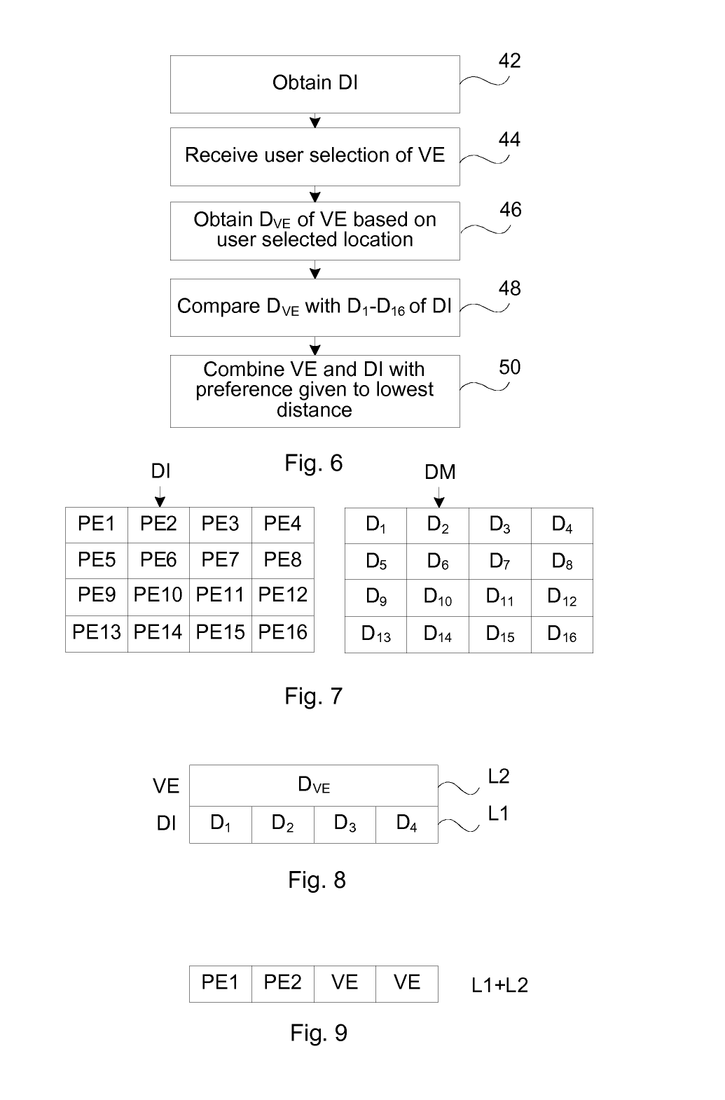

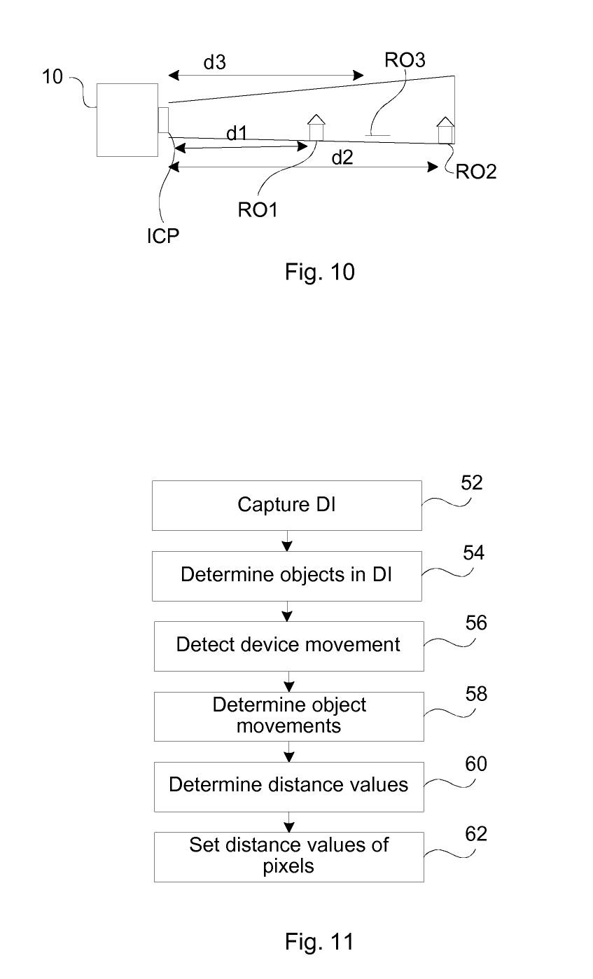

A first embodiment of the functioning of an image combining apparatus will now be given with reference being made to an exemplifying digital image DI shown in FIG. 4a, to an exemplifying virtual entity VE, shown in FIG. 4b, being combined into a combined image shown in FIG. 5 employing the method steps shown in FIG. 6. Reference will also be made to FIG. 7, which shows the pixels of the digital image together with a distance map with distances associated with the pixels, to FIG. 8, which schematically shows the providing of the virtual entity on top of the digital image, to FIG. 9, which schematically shows an example of a combined virtual entity and digital image, and to FIG. 10, which schematically shows the capturing of real objects in the digital image and their placement in relation to an image capturing position.

A user may desire to combine a digital image DI with a virtual entity and may for this reason contact or directly use the image combining apparatus. In order to be able to perform the combining, the apparatus therefore obtains the digital image DI, step 42. This may be done through the digital image obtaining unit 30 fetching a digital image from an image library, for instance in the mobile terminal. The digital image obtaining unit 30 may also receive the digital image DI from the image capturing unit 18. As yet another alternative the digital image DI may be obtained from an image server that is accessed via a communication network, such as using the wireless network 10. It is also possible that an image is received from another mobile terminal or another user via an electronic message such as an SMS, or e-mail. There are thus countless ways in which the digital image obtaining unit may obtain a digital image DI. Before, after or at the same time as the digital image DI is obtained, the user selection receiving unit 32 receives a user selection of a virtual entity VE, step 44. This selection may be received via a user interface of the mobile terminal 12, for instance via the display 16 that may be a touch screen.

The virtual entity VE may likewise be an entity that is obtained from a library, for instance in the mobile terminal 12, from the image capturing unit 18, from a server accessed via a communication network as well as from another mobile terminal or another user via an electronic message such as an SMS, or e-mail. The virtual entity VE may also be created, in real-time or beforehand, by the user or some other person using a suitable virtual entity generating application, such as the image capturing unit 18, a word processing application or a slide presentation generating application.

The digital image DI is, as is well known in the field, made of a number of picture elements, often denoted pixels, which elements comprise information of properties such as colour and intensity. Each pixel may thus be represented by a colour value. An exemplifying such structure is schematically shown in FIG. 7, where the digital image DI comprises a number of picture elements PE1-PE16, i.e. pixels. The picture elements are thus provided in a structure that together forms the digital image DI. The image is typically made up of objects, which may be identified or formed by groups of pixels having the same or similar properties. According to aspects of the invention, distance values are associated with the digital image DI. A distance value may define the distance of a real object to an image capturing position, which real object is represented by a formed object in the digital image. A distance value may be provided for such a formed object or a distance value may be provided for each pixel. In the latter case the pixels that together define the same object may have the same distance value. As can be seen in the example of FIG. 7, there is a distance map DM associated with the digital image DI, which distance map DM comprises a distance value D₁-D₁₆ for each pixel PE₁-PE₁₆ in the digital image DI. In the exemplifying FIG. 7 there is thus a one-to-one correspondence between distance values and pixels. An additional value may thus be provided for each pixel to represent a relative distance of a represented physical object. It should be noted that what is presented as one pixel throughout the description and claims could alternatively be a small group of pixels, such as for example a block or square of 4 or 16 pixels.

Each pixel thus has a corresponding distance value. It should be realize that the distance values need not be provided in a separate distance map. They can be provided as an additional property of the pixels. They may also be provided as metadata of the digital image.

The user may as an example have selected to combine the digital image DI in FIG. 4a with the virtual entity VE in FIG. 4b.

It can here be seen that the digital image DI comprises three exemplifying objects O1, O2 and O3, where each object is formed by a number or group of pixels, for instance a group of pixels having the same colour value. In the example there is a first object O1, a second object O2 and a third object O3. In this example the first and second objects O1 and O2 are buildings, while the third object O3 is a road.

As can be seen in FIG. 10, the real object RO1 that the first object O1 depicts is provided at a first distance d1 from an image capturing position ICP, which is a position from which the digital image DI was captured, the second real object RO2 depicted by the second object O2 is provided at a second distance d2 from the image capturing position ICP and the third real object RO3 depicted by the third object O3 is provided at a third distance d3 from the image capturing position ICP. The first distance d1 is here shorter than the second distance d2, which in turn is longer than the third distance d3. The pixels of the digital image DI forming the first object O1 will in this case have the same distance value, which distance value thus represents the first distance d1, the pixels forming the second object O2 will in a similar manner also have the same distance value, which distance value thus represents the second distance d2 and the pixels forming the third object O3 will in a similar manner also have the same distance value, which distance value thus represents the third distance d3.

Now, the user may want to place the virtual entity VE at a location in the digital image which is associated with a certain distance from the image capturing position ICP. The user may for this case manually enter a distance value D_{VE} for the virtual entity VE. As another possibility the digital image DI may be presented for the user and the user may click on an object in this image in order to select distance value of the virtual entity VE. The distance value D_{VE} assigned may then be a value reflecting a distance that is shorter, longer or essentially the same as the distance reflected by the distance value of the selected object. This means that the distance value obtaining unit 34 obtains or receives a distance value of the virtual entity VE based on a user selected location, i.e. based on a location that the user wants the virtual entity to appear to be presented at, step 46.

The user may in this case also have selected an area of the image, i.e. a number of pixels, which is to be combined with the virtual entity VE. The distance value capturing unit 36 then compares the distance value D_{VE} of the virtual entity VE with the distance values D1-D16 of the digital image DI, step 48.

The digital image DI may, as is shown in FIG. 8, be provided in a first presentation layer L1 of the display 16 and the virtual entity VE in a second presentation layer L2 adjacent the first presentation layer L1 and in this example on top of or over the first presentation layer L1. The comparison may thereby involve comparing the distance value D_{VE} of a section of the virtual entity VE in the second presentation layer L2 with distance value D1, D2, D3 or D4 of a corresponding section of the digital image in the first presentation layer L1, where these sections are aligned with each other. As can be seen in FIG. 8 the section of the digital image is in this embodiment a pixel. As can also be understood from FIG. 8 the distance values D1, D2, D3 and D4 of a first, second third and fourth pixel PE1, PE2, PE3 and PE4 are compared with the distance value D_{VE} of the virtual entity VE. The virtual entity VE may be made up of pixels that all have the same distance value.

After the comparison, the combiner 38 then combines the virtual entity VE and the digital image DI with preference given to the lowest distance, step 50. This means that the virtual entity VE or the digital image DI is selected if the corresponding distance value represents the lowest distance in the comparison. One example of such a selection is given in FIG. 9, where the combined layers L1+L2 are shown. Here the distance values D₁ and D₂ of the first and second pixels PE1 and Pe2 represent distances that are shorter than the distance represented by the distance value D_{VE} of the virtual entity VE, consequently the first and second pixels are selected for being presented. However, the distance values D3 and D4 of the third and fourth pixels PE1 and Pe2 represent distances that are longer than the distance represented by the distance value D_{VE} of the virtual entity VE, and consequently the parts or sections of the virtual entity VE that are aligned with the third and fourth pixels PE3 and PE4 are selected.

The comparison may be a comparison on a pixel level. This means that all the pixels in the area selected for the combination are compared with the distance value assigned to the virtual entity and in this selection the distance values representing a lower distance to the image capturing position are given preference. This may involve selecting the pixels of the digital image if they represent a distance closer to the image capturing position and the virtual entity if this has a distance value representing a distance that is closer to the image capturing position.

As could be seen above, the combiner 38 may select parts of a layer for presentation for which parts the distance values represent a shorter distance to image capturing position ICP. The presenting unit 40 may then make sure that the combined digital image and virtual entity are presented, for instance via the display 16. It is also possible that the combined image is sent from the image combining apparatus to another device for being presented there. This could for instance be the case if the image combining apparatus is provided in the server 14. Thus it is clear that the presenting unit 40 is optional

An example of what a combined image could look like is shown in FIG. 5. Here the user has selected that the virtual entity VE is to be closer to the image capturing position ICP than the second object O2, but further away from the image capturing position ICP than the first object O1. The user may more particularly have selected the virtual entity VE to have the same position as the third object O3. As can be seen in FIG. 5 the virtual entity VE will be shown instead of the digital image DI in those areas where it has a distance value reflecting a lower distance to the image capturing position ICP than the corresponding object O2 of the digital image DI and that the digital image DI will be presented in the area where the distance value of the virtual entity VE represents a longer distance than the distance value of the corresponding object O1. As can be seen in the example of FIG. 5, the virtual entity VE will therefore seem to be placed in front of the second object O2, but behind the first object O1.

It can in this way be seen that the virtual entity VE can be combined with the digital image and a depth effect is obtained even though they are both two-dimensional.

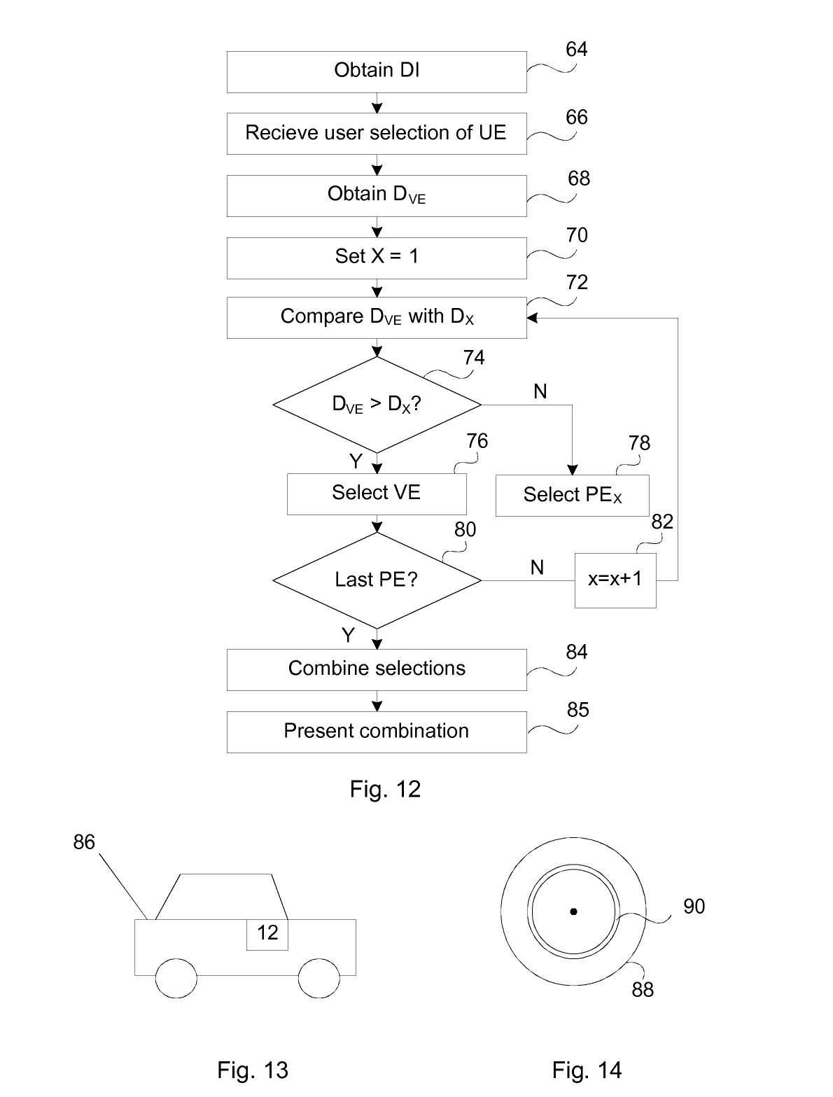

A second embodiment will now be described with reference being made to the previously mentioned FIGS. 1-5 and 7-10, as well as to FIG. 11, which shows a number of method steps being performed in order to determine distance values of a digital image, and to FIG. 12, which shows a number of method steps being performed in a second variation of a method of combining a virtual entity with a digital image.

In this embodiment the user captured an image DI using the image capturing unit 18 of the mobile terminal 12, step 52, which may be done in a known fashion. However in this embodiment the image capturing unit may also be configured to determine objects in the digital image, step 54.

This may be done in a number of ways. The image capturing unit 18 may for instance analyse the pixels with regard to colour and group the pixels according to the analysis for forming the objects O1, O2 and O3, where neighbouring pixels having the same or similar colour values are considered to form the same object. The image capturing unit 18 may then detect the apparatus movement, step 56. Thereby it also detects the movement of the image capturing position ICP. This may be detected through a suitable sensor, such as a gyro or an accelerometer.

The determining of objects is not necessarily made by the image capturing unit. It is also possible that the memory 24 comprises instructions causing the processor 22 to determine the formed objects O1, O2, O3 in the digital image (DI), which instructions may be provided in the form of an object forming unit.

The image capturing unit 18 may also detect the movement of objects in the digital image DI, step 58. The movement may be detected through detecting how the objects change positions in the viewfinder 20. Based on the detected movement of the image capturing unit and the detected movement of the objects, the distance values of the formed objects are then determined, step 60. This may be done using an autofocus function of the image capturing unit 18. However, the focus length may be fairly short and therefore the distance estimation may be a bit inaccurate. It is also possible to analyse the objects presented in the viewfinder 20 and compare these with the captured digital image DI.

How this can be done can be understood from FIG. 10 and the example of the three objects O1, O2 and O3 in the digital image DI.

A view is captured in the digital image DI by the mobile terminal 12 at the image capturing position ICP, where the first real object RO1 in the view is located at the first distance d1, the second real object RO2 at the second real distance d2 and the third real object RO3 at the third distance d3. Now, if the image capturing position ICP is moved, for instance vertically or horizontally, the position of the objects as seen in the viewfinder 20 will change. The objects O1, O2 and O3 in the viewfinder 20 will thus move. The amount of change in position in the viewfinder is here inversely proportional to the distance of the real object from the image capturing position and the viewfinder 20. This means that an object depicting a real object that is located a long distance from the image capturing position will move very little, while an object depicting a real object located a close distance from the image capturing position ICP will move more. Also speed may be a factor. This knowledge can then be used for determining the distances, step 60. After the distance values of the object have been determined, then the distance values of the pixels of the digital image DI are set, step 62.

This determination is not necessarily performed in the image capturing unit 18, but may instead also be performed by the processor 22 acting on further instructions in the memory 24, which instructions may be provided in the form of a distance value determining unit, which determines the distance values D1-D16 of the objects based on detected movement of the image capturing position. The distance value determining unit may then also be configured to determine the movement of the formed objects O1, O2, O3 in relation to the detected movement of the image capturing position.

The proposed distance determinations scheme can be compared with face detection used in many image capturing units. In the face detection case, the image capturing unit analyses the images and tries to find patterns which matches a face. As an alternative it is possible to focus on the pixel level instead of the physical object, i.e. to investigate the movement of each pixel.

A distance map DM is thus set for the digital image DI, which may be a map providing a distance value for every pixel in the digital image DI, as shown in FIGS. 4a and 4b. As an alternative it is possible that distance values are only provided for the different objects that are identified.

In the map a high distance value may indicate a short distance from the image capturing position ICP and a low value may indicate a long distance to the image capturing position ICP. The values may furthermore be normalized. The distance map DM may be provided as a bitmap, which stores information about relative distances of all pixels of the digital image DI. It may be seen as similar to Exchangeable Image File format (Exif) information. The values can range between one and zero with one representing a position close to the image capturing unit 18 and zero representing infinity. With this extra information for each pixel, it is easy to overlay any virtual entity at any distance behind and before other objects of a digital image.

If determined in image capturing unit 18, the digital image DI and distance map DM are then provided from the image capturing unit 18 to the digital image obtaining unit 30, which thereby obtains the digital image DI with associated distance map DM, step 64.

The user selection receiving unit 32 then receives a user selection of the virtual entity, step 66, which may yet again be received via the display 16.

Thereafter a user selection of a distance D_{VE} of the virtual entity is also received by the distance value obtaining unit 34, step 68, for instance through the user indicating an object in the digital image such as the third object O3.

It is at the same time possible that an area of the digital image where the combination is to be performed is indicated by the user. This may be done through specifying coordinates in the digital image DI or through marking an area with a cursor. As a default setting it is possible that the virtual entity VE is compared with the whole digital image DI.

Thereafter a pixel counter x is set, here to a value of one, step 70, and a pixel in the area corresponding to the set pixel counter is selected. The distance value D_{VE} of the virtual entity VE is then compared with the distance value Dₓ of the pixel PEE, step 72.

If the distance value D_{VE} of the virtual entity VE is higher than the distance value Dx of the pixel PE_{Ex} step 74, then the virtual entity VE is selected for the pixel position. If however it is not, i.e. if the distance value DE of the pixel PEₓ is higher, step 74, then the pixel PEₓ is selected, step 78. As mentioned above a higher distance may in this specific example denote a lower distance to the image capturing position. It is of course possible with the opposite situation and then a lower value would lead to a selection.

Thereafter there is a check of if investigated pixel was the last pixel in the area or not, step 80. This would be the case if the pixel counter had a value corresponding to the last pixel of the area. If the pixel was not the last pixel, step 80, then the value of the pixel counter is changed and in this example incremented, step 82, and a next pixel is selected and compared with a corresponding part of the virtual entity, step 72.

If the pixel was the last pixel, step 80, then the selections are combined, step 84. The selections may for instance be combined into a new digital image. Thereafter the combination is presented, step 85, or alternatively stored in a memory. It should here also be realized that the counter could be operated in the opposite way, i.e. count from a high to a low value. As the digital image may be provided in a first presentation layer with the virtual entity provided in a second presentation layer on top of the first presentation layer, the combining may involve always presenting the digital image, presenting a part of the virtual entity when the virtual entity is selected and not presenting the part of the virtual entity when the digital image is selected. As the digital image is provided below the virtual entity, a section of this digital image that is covered by a specific virtual entity part will not be visible when this virtual entity part is presented. However, the section will be visible if the part is not presented.

In this way there is thus obtained a combination where a depth effect is obtained. This leads to a better and more realistic combination of the virtual entity with the digital image. This may be useful if it is necessary to attach a virtual entity to an object in a digital image.

Some variations were described above. It should be realized that there are further variations that are possible to make. It is possible that the distance values in the distance map DM are updated in real time. The image information with distance map may because of this also be stored in a temporal storage, for instance in the image capturing unit.

It is also possible that the location, i.e. depth, at which the virtual entity is to be placed, is determined first and that distance values for the pixels are calculated after that. The display of the virtual entity may be made after this, where the pixels of the virtual entity which have smaller distance values, i.e., represent longer distances, than the pixels of the digital images will be removed.

A further variation is that a virtual entity may be assigned several distance values. Different parts or sections of a virtual entity may thus have different distance values.

The previously described third object may for instance be associated with several different distances. In this case the object may be divided into parts of similar distance values. It is for instance possible to determine the change in position of different parts of the object in the viewfinder in relation to movement of the image capturing position and then the parts that have the same amount of movement will have the same distance value. Such a part may be as small as a pixel or a block of pixels.

The image combining arrangement is not limited to being provided in a mobile terminal 12. It may as an example also be provided in a vehicle, such as a car 86 or a truck. One such realization is shown in FIG. 13. In this case the image combining apparatus may with advantage be combined with for instance a navigation system such as a navigation system employing Global Positioning System (GPS). Another possible location is in a vessel, such as a ship or an aeroplane.

As mentioned earlier, the digital image obtaining unit 30, the user selection receiving unit 32, the distance value obtaining unit 34, the distance value comparing unit 36, the combiner 38 and the presenting unit 40, which latter unit is optional, may be provided in the form of instructions that are executable by the processor or as hardware circuits. These units may also be considered to form means 30 for obtaining a digital image comprising picture elements, where the digital image has been captured at an image capturing position and the picture elements form different objects, where each formed object has at least one distance value, where the distance value represents the distance between the image capturing position and a real object that the corresponding formed object depicts, means 32 for receiving a user selection of a virtual entity to be combined with the digital image, means 34 for obtaining at least one distance value D_{VE} associated with the virtual entity VE representing the distance between a user selection of a location at which location the virtual entity is to appear to be placed and the image capturing position, means 36 for comparing the distance value of the virtual entity with the distance values in the digital image, means 38 for combining the virtual entity with the digital image to create a combined image based on the comparison and with preference given to the lowest distance, and means for presenting the combined image and virtual entity.

The means for combining may also be considered to comprise means for selecting a part of the virtual entity or an object of the digital image for which the corresponding distance value represents the shortest distance to the image capturing position, where the creating is based on the selected part or object.

As the digital image may be provided in the first presentation layer L1 and the virtual entity may be provided in the second presentation layer L2 adjacent the first presentation layer, the means for selecting may be considered to comprise means for selecting parts of a corresponding layer for presentation.

As the memory 24 may comprise instructions causing the image combining apparatus to determine the distance values D1-D16 of the objects based on detected movement of the image capturing position, the image combining apparatus may also be considered as comprising means for determining the distance values D1-D16 of the objects based on detected movement of the image capturing position.

As the memory 24 may comprise instructions causing the image combining apparatus to determine the formed objects O1, O2, O3 in the digital image DI the distance value determining means for determining the distance values may furthermore be considered to comprise means for determining the movement of the formed objects O1, O2, O3 in relation to the detected movement of the image capturing position.

As the user selection receiving unit may also receive user instructions con-cerning an area in the digital image that is to be combined with the virtual entity, the means for receiving a user selection may further be considered to comprise means for obtaining data specifying an area in the digital image that is to be combined with the virtual entity.

The instructions mentioned that are provided in the memory 24, may be provided as computer program code 90 of a computer program for combining a virtual entity VE with a digital image DI, which computer program code causes the processor to perform the above described activities. This computer program with computer program code 90 may be provided as computer program product, where the computer program product is provided on a data carrier (88) comprising the computer program code (90). One such carrier is schematically indicated in FIG. 14.

While the invention has been described in connection with what is presently considered to be most practical and preferred embodiments, it is to be understood that the invention is not to be limited to the disclosed embodiments, but on the contrary, is intended to cover various modifications and equivalent arrangements. Therefore the invention is only to be limited by the following claims.

1. An image combining apparatus comprising a processor and memory, said memory containing instructions executable by said processor to cause said image combining apparatus to:
obtain a digital image comprising picture elements, said digital image having been captured at an image capturing position and the picture elements forming different objects, where each formed object has at least one distance value, said distance value representing the distance between the image capturing position and a real object that the corresponding formed object depicts,
receive a user selection of a virtual entity to be combined with the digital image,
obtain at least one distance value associated with the virtual entity representing the distance between a user selection of a location at which location the virtual entity is to appear to be placed and the image capturing position,
compare the distance value of the virtual entity with the distance values in the digital image, and
combine the virtual entity with the digital image to create a combined image based on the comparison and with preference given to the lowest distance.

2. The image combining apparatus according to claim 1, wherein the instructions to combine comprises instructions to select either a part of the virtual entity or a formed object of the digital image for which the corresponding distance value represents the shortest distance to the image capturing position, the creating being based on the selected part or object.

3. The image combining apparatus according to claim 2, wherein the digital image is provided in a first presentation layer and the virtual entity in a second presentation layer adjacent the first layer where the instructions to select comprises instructions to select parts of a corresponding layer for presentation.

4. The image combining apparatus according to claim 1, wherein said instructions further comprise instructions causing said image combining apparatus to present the combined digital image and virtual entity.

5. The image combining apparatus according to claim 1, further comprising an image capturing unit configured to capture the digital image, said instructions further comprising instructions causing said image combining apparatus to determine the distance values of the objects based on detected movement of the image capturing position.

6. The image combining apparatus according to claim 5, said instructions further comprising instructions causing said image combining apparatus to determine the formed objects in the digital image and determine the distance values through determining the movement of these formed objects in relation to the detected movement of the image capturing position.

7. The image combining apparatus according to claim 5, wherein the image capturing unit is configured to detect the movement of the image capturing position.

8. The image combining apparatus according to claim 5, further comprising a detector configured to detect the movement of image capturing position.

9. The image combining apparatus according to claim 1, said image combining apparatus being further operative to obtain data specifying an area in the digital image that is to be combined with the virtual entity.

10. A vehicle or a vessel comprising the image combining apparatus according to claim 1.

11. A method of combining a virtual object with a digital image being performed in an image combining apparatus and comprising:
obtaining the digital image comprising picture elements, said digital image having been captured at an image capturing position and the picture elements forming different objects, where each formed object has at least one distance value, said distance value representing the distance between the image capturing position and a real object that the corresponding formed object depicts,
receiving a user selection of a virtual entity to be combined with the digital image,
obtaining at least one distance value associated with the virtual entity representing the distance between a user selection of a location at which location the virtual entity is to appear to be placed and the image capturing position,
comparing the distance value of the virtual entity with the distance values in the digital image, and
combining the virtual entity with the digital image to create a combined image based on the comparison and with preference given to the lowest distance.

12. The method according to claim 11, wherein the combining comprises either selecting a part of the virtual entity or a formed object of the digital image for which the corresponding distance value represents the shortest distance to the image capturing position in the comparison, the creating being based on the selected part or object.

13. The method according to claim 12, wherein the digital image is provided in a first presentation layer and the virtual entity in a second presentation layer adjacent the first layer where the selecting comprises selecting parts of a corresponding layer for presentation.

14. The method according to claim 11, further comprising presenting the combined digital image and virtual entity.

15. The method according to claim 11, further comprising capturing the digital image and determining the distance values of the objects based on detected movement of the image capturing position.

16. The method according to claim 14, further comprising determining the formed objects in the digital image and determining the distance values through determining the movement of these formed objects in relation to the detected movement of the image capturing position.

17. The method according to claim 11, further comprising obtaining location data specifying where in the digital image the virtual entity is to be placed.

18. A computer program product comprising a non-transitory computer readable storage medium storing computer program code for combining a virtual object with a digital image, the computer program code which when run in an image combining apparatus, causes the image combining apparatus to:
obtain the digital image comprising picture elements, said digital image having been captured at an image capturing position and the picture elements forming different objects, where each formed object has at least one distance value, said distance value representing the distance between the image capturing position and a real object that the corresponding formed object depicts, and
receive a user selection of a virtual entity to be combined with the digital image,
obtain at least one distance value associated with the virtual entity representing the distance between a user selection of a location at which location the virtual entity is to appear to be placed and the image capturing position,
compare the distance value of the virtual entity with the distance values in the digital image, and
combine the virtual entity with the digital image to create a combined image based on the comparison and with preference given to the lowest distance.

19. (canceled)
